(19) United States
(12) Patent Application Publication
(10) Pub. No.: US 2013/0003192 A1
(43) Pub. Date: Jan. 3, 2013

(54) Method for designing objective lens and objective lens

(75) Inventor: Mitsuru ITO, Zama-shi (JP)

(73) Assignees: SANYO OPTEC DESIGN CO., LTD., Gunma-ken (JP); SANYO ELECTRIC CO., LTD., Osaka (JP)

(21) Appl. No.: 13/357,806

(22) Filed: Jan. 25, 2012

(30) Foreign Application Priority Data
Jan. 27, 2011 (JP) 2011-014929

(51) Int. Cl. G06F 17/50; G02B 13/18

(52) U.S. Cl. 359/708; 703/1

(57) ABSTRACT

A method for designing an objective lens includes: designing a first objective lens, having no annular zone formed on an incident surface on an opposite side to an optical-disc-facing side according to a first optical design with which a laser beam is condensed on a layer between first and second signal recording layers of an optical disc, under conditions including a third temperature between first and second temperatures, and including a third wavelength between first and second wavelengths; and designing a second objective lens, having an annular zone formed on the incident surface of the first objective lens, according to a second optical design with which the laser beam is condensed on the second signal recording layer under the conditions including the second temperature and wavelength the annular zone having such an aspheric coefficient that spherical aberration becomes smaller than that of the first objective lens.

### CROSS-REFERENCE TO RELATED APPLICATION

This application claims the benefit of priority to Japanese Patent Application No. 2011-014929, filed Jan. 27, 2011, of which full contents are incorporated herein by reference.

### BACKGROUND OF THE INVENTION

1. Field of the Invention

The present invention relates to a method for designing an objective lens included in an optical pickup apparatus configured to perform an operation of reading signals recorded in an optical disc and an operation of recording signals into an optical disc using a laser beam, and an objective lens formed with the method for designing an objective lens.

2. Description of the Related Art

Optical disc apparatuses are widely used that can apply a laser beam emitted from an optical pickup apparatus to a signal recording layer of an optical disc to perform a signal reading operation and a signal recording operation.

Although optical disc apparatuses using optical discs called CD and DVD are generally used, optical disc apparatuses are recently developed that use optical discs with improved record densities, i.e., optical discs of the Blu-ray standard.

In contrast to the CD-standard and DVD-standard optical discs, a laser beam having a shorter wavelength, such as blue-violet light having a wavelength of 405 nm is used as a laser beam for performing the operation of reading signals recorded in a Blu-ray-standard optical disc.

A protective layer provided on a top surface of a signal recording layer of the Blu-ray-standard optical disc has a thickness of 0.1 mm, and a numerical aperture is set at 0.85 in an objective lens used for performing the operation of reading signals from the signal recording layer.

An optical pickup apparatus is used for the operation of reading signals recorded on the signal recording layer provided in the Blu-ray-standard optical disc and for recording signals onto the signal recording layer, and in such an optical pickup apparatus, it is necessary to reduce a diameter of a laser spot generated by condensing a laser beam using an objective lens. The objective lens used for acquiring a desired laser spot shape has not only an increased numerical aperture but also a reduced focal length, resulting in the characteristics of a reduced curvature radius in the objective lens.

Such an optical pickup apparatus uses plastic for the objective lens in order to reduce overall weight and manufacturing cost. The objective lens made of plastic has a problem that refractive index variation is great due to temperature change as compared to that made of glass. Particularly in the case of the optical pickup apparatus using the objective lens having a larger numerical aperture such as that for the Blu-ray-standard optical disc, there is a problem that refractive index variation caused by temperature change considerably affects the focusing characteristics of the objective lens and causes spherical aberration causing a signal reading operation to be disabled.

As a method for correcting the spherical aberration caused by such temperature change, a method for correcting the spherical aberration caused by temperature change by the annular zone provided on the incidence surface of the objective lens is often employed. However, in order to form such an annular zone on the incident surface of the objective lens, there are problems not only that the annular zone is required to precisely designed but also that accuracy of a mold is required to be improved.

Further, in the optical pickup lens used for the Blu-ray standard, the spherical aberration cannot be completely corrected only by providing the annular zone on the optical pickup lens, and a method of moving a collimator lens in the light axis direction is employed.

In an optical pickup apparatus including a plastic objective lens without the above described annular zone, the method of moving a collimator lens in the light axis direction is often employed as a method for correcting the spherical aberration caused in association with temperature fluctuation because no annular zone is formed in the optical pickup lens (see Patent Document 1: Japanese Laid-Open Patent Publication No. 2008-4169).

Some commercialized optical pickup apparatuses include tilt adjustment mechanisms each configured to adjust the light axis of the optical lens in accordance with warpage of an optical disc. When aberration correction sensitivity is defined as a degree of third-order coma aberration caused when the light axis of the objective lens is tilted in association with a tilt control operation, the aberration correction sensitivity has such characteristics as to be reduced as temperature rises to a high temperature.

When using the objective lens made of plastic, there is such a problem that various signals is deteriorated by residue and fluctuation of coma aberration caused by reduction in the aberration correction sensitivity that is caused in association with higher temperature, and a technique for solving such a problem has been suggested (see Patent Document 2: Japanese Laid-Open Patent Publication No. 2010-170634).

For optical discs of the Blu-ray-standard, an optical disc including a plurality of signal layers such as two layers, three layers, and four layers has been suggested to increase a recording capacity and commercialized. For example, in an optical disc including four signal recording layers, a signal recording layer L1 (depicted in FIG. 14) located at a position closest to the incident surface of the optical disc is disposed at a position of about 0.05 mm from the incident surface, and a signal recording layer L2 (depicted in FIG. 14) located at a position farthest from the incident surface of the optical disc is disposed at a position of about 0.1 mm from the incident surface. Other two signal recording layers are disposed between the above described two signal recording layers L1 and L2.

FIG. 14 depicts a relationship between an aspheric objective lens R made of plastic, which is manufactured according to optical design, and an optical disc D, and the optical design of the objective lens is implemented such that the focusing operation is performed for the signal recording layer located between the signal recording layer L1 and the signal recording layer L2 when the optical pickup apparatus is used at an ambient temperature of 35° C., for example.

Although the objective lens R is displaced in a direction orthogonal to a surface of the optical disc D to perform a signal reading operation, when the focusing position of the laser beam is changed from the signal recording layer L1 to L2, spherical aberration is caused with a change in thickness of the protective layer. To correct such a spherical aberration, a correction method of moving the collimator lens in the light axis direction is often employed as described in Patent Document.

If the objective lens made of plastic is used as the objective lens included in the optical pickup apparatus configured to be capable of reading signals recorded in the optical disc provided with the above described four signal recording layers, it is affected by temperature fluctuations.

Although the technique described in Patent Document 2 is employed for correcting the effect of temperature fluctuations, such a technique is directed to design for condensing the laser beam on the signal recording layer at a position of a predetermined distance from the incident surface of the optical disc and design also enabling usage of other signal recording layers.

In such a configuration, design, made such that the laser beam is condensed on the signal recording layer at a predetermined position, causes a problem that signal reading characteristics for the other layers deteriorate.

### SUMMARY OF THE INVENTION

A method for designing an objective lens according to an aspect of the present invention, which is included in an optical pickup apparatus configured to read, using a laser beam, signals recorded in an optical disc having a first signal recording layer and a second signal recording layer, the second signal recording layer located at a distance from a laser beam incident surface longer than a distance from the incident surface to the first signal recording layer, the method includes: designing a first objective lens, having no annular zone formed on an incident surface on an opposite side to a side facing the optical disc, in accordance with a first optical design with which the laser beam is condensed on a layer between the first and the second signal recording layers, under conditions including a third temperature between a first temperature and a second temperature higher than the first temperature within a temperature range set as use environment of the optical pickup apparatus, and including a third wavelength between a first wavelength and a second wavelength longer than the first wavelength within a wavelength range of the laser beam set as the use environment of the optical pickup apparatus; and designing a second objective lens in accordance with a second optical design with which the laser beam is condensed on the second signal recording layer under the conditions including the second temperature and the second wavelength, the second objective lens having an annular zone formed on the incident surface of the first objective lens, the annular zone having such an aspheric coefficient that spherical aberration becomes smaller than spherical aberration of the first objective lens.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1A is a diagram illustrating a method for designing an objective lens according to an embodiment of the present invention;

FIG. 1B is a diagram illustrating a method for forming an annular zone of an objective lens according to an embodiment of the present invention;

FIG. 2 is a cross-sectional diagram of an objective lens according to an embodiment of the present invention;

FIGS. 3A to 3C are diagrams of condition data used in a method for designing an objective lens according to an embodiment of the present invention;

FIG. 4A is a diagram of aspheric coefficient data used in a method for designing an objective lens according to an embodiment of the present invention;

FIG. 4B is a diagram of aspheric coefficient data used in a method for designing an objective lens according to an embodiment of the present invention;

FIG. 5A is a diagram of aspheric coefficient data used in a method for designing an objective lens according to an embodiment of the present invention;

FIG. 5B is a diagram of aspheric coefficient data used in a method for designing an objective lens according to an embodiment of the present invention;

FIG. 6 is a diagram of aspheric coefficient data used in a method for designing an objective lens according to an embodiment of the present invention;

FIG. 7 is a diagram of aspheric coefficient data used in a method for designing an objective lens according to an embodiment of the present invention;

FIGS. 8A to 8E are diagrams of condition data and aspheric coefficient data used in a method for designing a common objective lens;

FIG. 9 is a diagram of data used in a method for designing an objective lens according to an embodiment of the present invention;

FIG. 10 is a diagram of data used in a method for designing a common objective lens;

FIG. 11 is a schematic diagram for describing an optical system of an optical pickup apparatus in which an objective lens according to an embodiment of the present invention is used;

FIG. 12 is a diagram for describing an objective lens according to an embodiment of the present invention;

FIG. 13 is a diagram for describing an objective lens according to an embodiment of the present invention; and

FIG. 14 is a diagram for describing a common objective lens.

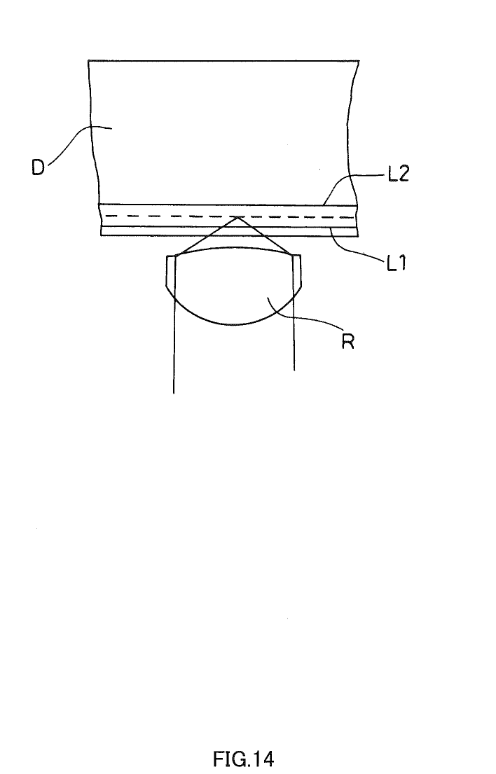

### DETAILED DESCRIPTION OF THE INVENTION

At least the following details will become apparent from descriptions of this specification and of the accompanying drawings.

An embodiment according to the present invention is directed to providing an objective lens of an optical pickup apparatus capable of solving the above described problems by considering thicknesses of different layers in the same optical disc as well as a temperature range of use environment and a wavelength range of use.

That is to say, in an embodiment of the present invention, when L1 is a signal recording layer located closest to a laser beam incident surface of an optical disc, L2 is a signal recording layer located the farthest therefrom, H2 and H3 are a low temperature and a high temperature, respectively, satisfying performance of an optical pickup apparatus, λ2 is a short wavelength of the laser beam, and λ3 is a long wavelength thereof, a basic optical design is performed, where a reference temperature H1 is between the high temperature H3 and the low temperature H2 and a reference wavelength λ1 is between the short wavelength λ2 and the long wavelength λ3, and the laser beam having the reference wavelength λ1 is condensed on L0 between the signal recording layer L1 and the signal recording layer L2 at the reference temperature H1, while an annular zone step is formed on an incident surface such that the laser beam having the long wavelength λ3 is condensed on the signal recording layer L2 at the high temperature H3 and an aspheric coefficient of the annular zone steps is set such that spherical aberration is reduced.

That is to say, in the case of the use environment with the highest temperature H3 and the longest wavelength λ3, when plastic is used as a material for the objective lens, the refractive index is the lowest, thereby facilitating, in this case the most, condensing on the far side from the incident side of the optical disc. In the case of the use environment with the lowest temperature H2 and the shortest wavelength λ2, when plastic is used as a material for an optical pickup lens, the refractive index is the highest, thereby facilitating, in this case the most, condensing on the near side from the incident side of the optical disc.

In other words, the maximum and the minimum thicknesses of the signal recording layers of the optical disc are matched to the respective states, i.e., the signal recording layer thickness L2 of the optical disc is assumed for the use environment with the highest temperature H3 and the longest wavelength λ3, and the signal recording layer thickness L1 of the optical disc is assumed for the use environment with the lowest temperature H2 and the shortest wavelength λ2, thereby making the setting such that the spherical aberration is reduced in these cases.

According to an embodiment of the present invention, the annular zone steps are formed on the incident surface of the objective lens such that the laser beam is condensed on two points having different distances from the incident surface of the optical disc under the conditions of different temperatures and wavelengths, and thus the signal reading characteristics for a number of signal recording layers can be improved in the optical pickup apparatus.

An embodiment of the present invention relates to an objective lens having a function of condensing a laser beam emitted from a laser diode onto a signal recording layer provided in an optical disc, and particularly to an objective lens included in an optical pickup apparatus capable of performing an operation of reading signals recorded in an optical disc having a plurality of signal recording layers.

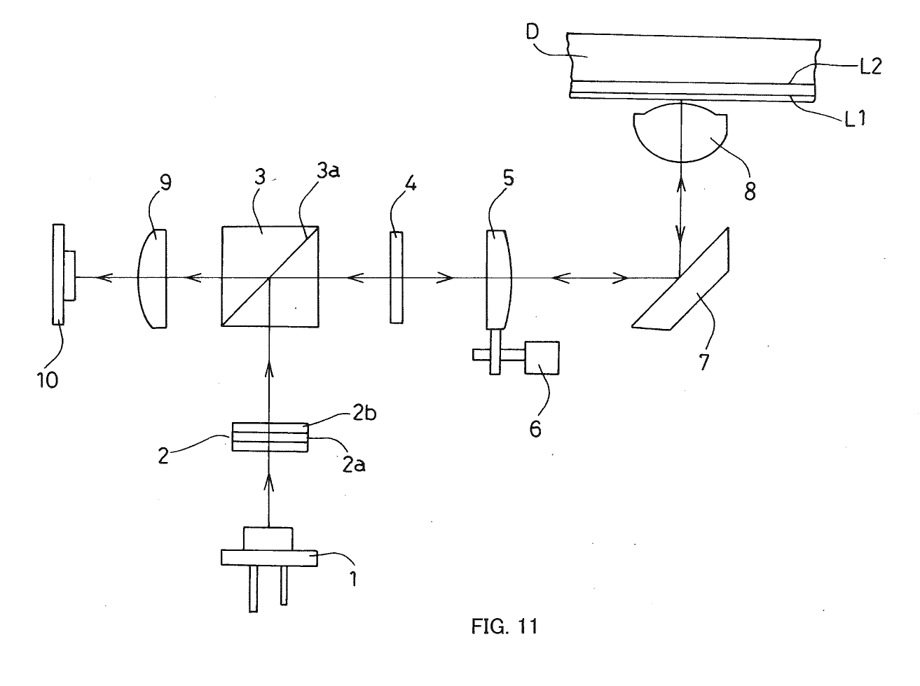

An optical system of the optical pickup apparatus including the objective lens according to an embodiment of the present invention will be described with reference to an embodiment depicted in FIG. 11.

In FIG. 11, reference numeral 1 denotes a laser diode that emits a laser beam of blue-violet light having a wavelength of 405 nm, for example, and reference numeral 2 denotes a diffraction grating that the laser beam emitted from the laser diode 1 enters and the diffraction grating includes: a diffraction grating unit 2a that splits the laser beam into a main beam of zero-order light and two sub-beams of plus first-order diffracted light and minus first-order diffracted light; and a half-wave plate 2b that converts the incident laser beam into S-direction linear polarized light.

Reference numeral 3 denotes a polarizing beam splitter on which the laser beam having passed through the diffraction grating 2 enters and the polarizing beam splitter is provided with a control film 3a configured to reflect a great portion of the laser beam converted into the S-polarized light and allow the laser beam polarized in the P-direction to pass therethrough.

Reference numeral 4 denotes a quarter-wave plate provided at a position where the laser beam reflected by the control film 3a of the polarizing beam splitter 3 is incident, and the quarter-wave plate has a function of converting the incident laser beam from linear polarized light into circular polarized light, and to the contrary, from circular polarized light into linear polarized light. Reference numeral 5 denotes a collimator lens that the laser beam having passed through the quarter-wave plate 4 enters and that converts the incident laser beam into parallel light, and the collimator lens is configured to be displaced in a light axis direction by an aberration correcting motor 6. The displacement operation of the collimator lens 5 in the light axis direction can correct the spherical aberration caused by a thickness of a protective layer provided between signal recording layers L1, L2 and a disc surface of an optical disc D.

Here, the signal recording layer L1 is a signal recording layer provided at the position closest to the laser beam incident surface of the optical disc D; the signal recording layer L2 is a signal recording layer provided at the position farthest from the laser beam incident surface of the optical disc D; and if the optical disc D is of the Blu-ray standard, the positions of the signal recording layer L1 and the signal recording layer L2 are located at about 0.05 mm and 0.105 mm, respectively, from the incident surface. If the optical disc D is an optical disc including four signal recording layers, two signal recording layers are disposed between the signal recording layers L1 and L2.

Reference numeral 7 denotes a raising mirror provided at a position where the laser beam having passed through the collimator lens 5 is incident, and the raising mirror has a function of changing the emitting direction of the incident laser beam by 90 degrees and reflecting the laser beam toward an objective lens 8 provided to condense the laser beam on the signal recording layer L1 or L2 of the optical disc D.

In such a configuration, a laser beam emitted from the laser diode 1 is incident on the objective lens 8 via the diffraction grating 2, the polarizing beam splitter 3, the quarter-wave plate 4, the collimator lens 5, and the raising mirror 7, and thereafter is applied as a laser spot to the signal recording layer L1 or L2 of the optical disc D through the condensing operation of the objective lens 8, and the laser beam applied to the signal recording layer L1 or L2 is reflected as return light toward the objective lens 8.

The return light reflected from the signal recording layer L1 or L2 of the optical disc D is incident on the control film 3a of the polarizing beam splitter 3 through the objective lens 8, the raising mirror 7, the collimator lens 5, and the quarter-wave plate 4. The return light incident on the control film 3a of the polarizing beam splitter 3 as such has been converted into P-direction linear polarized light by the phase shift operation of the quarter-wave plate 4. Therefore, such return light is not reflected by the control film 3a, but is allowed to pass through the control film 3a as a control laser beam.

Reference numeral 9 denotes a sensor lens that the control laser beam having passed through the control film 3a of the polarizing beam splitter 3 enters, and the sensor lens has a function of applying the control laser beam with astigmatism added, to a light-receiving portion provided on a photodetector 10 called PDIC. The photodetector 10 is provided with a four-divided sensor which will be described later, and the like, and is configured to perform a signal generating operation associated with an operation of reading signals recorded on the signal recording layer L1 or L2 of the optical disc D and an operation of generating a focus error signal for performing a focus control operation using an astigmatic method, through an operation of applying the main beam, as well as perform an operation of generating a tracking error signal for performing a tracking control operation through an operation of applying the two sub-beams.

In the optical pickup apparatus with such a configuration, the objective lens 8 is displaced in a direction orthogonal to the surface of the optical disc D so as to condense the laser beam on the signal recording layers subjected to the signal residing operation, i.e., the signal recording layers L1, L2, and signal recording layers disposed between the signal recording layers L1 and L2.

The condensing operation of the objective lens 8 is performed for the signal recording layers, and the spherical aberration caused in this case is corrected by an operation of displacing the collimator lens 5 in the light axis direction in accordance with the aberration correcting motor 6. Such a control operation of the aberration correcting motor 6 can be performed by utilizing the magnitude of a signal acquired from the photodetector 10, such as a jitter value and/or a high-frequency signal, however, a known technique can be used for the control operation for such spherical aberration correction.

If the light axis of the objective lens 8 tilts relative to the signal surface of the optical disc D, so-called tilt correction operation is performed by correcting the light axis with a tilt correction mechanism included in the optical pickup apparatus.

Although the tilt correction operation is performed through a tilt control operation for the objective lens, aberration correction sensitivity indicative of a degree of correction of third-order coma aberration caused by the light axis displacement of the objective lens 8 has such characteristics as to be lowered as the refractive index of the objective lens 8 is reduced in association with high temperature

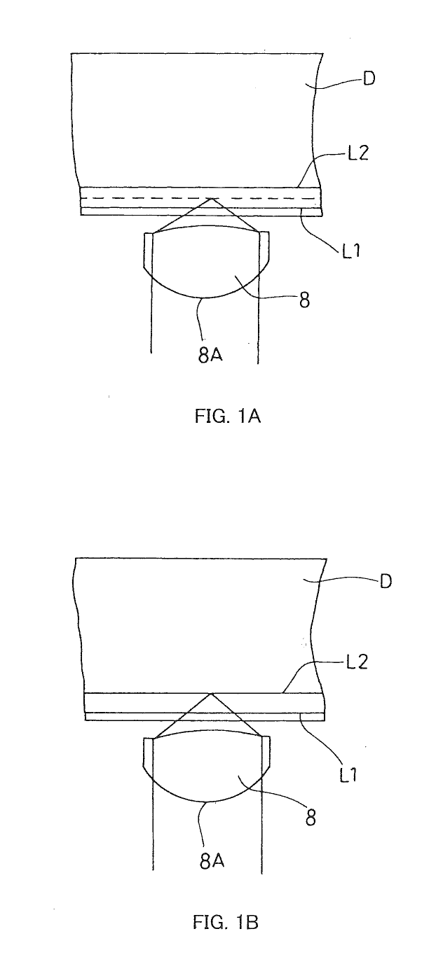

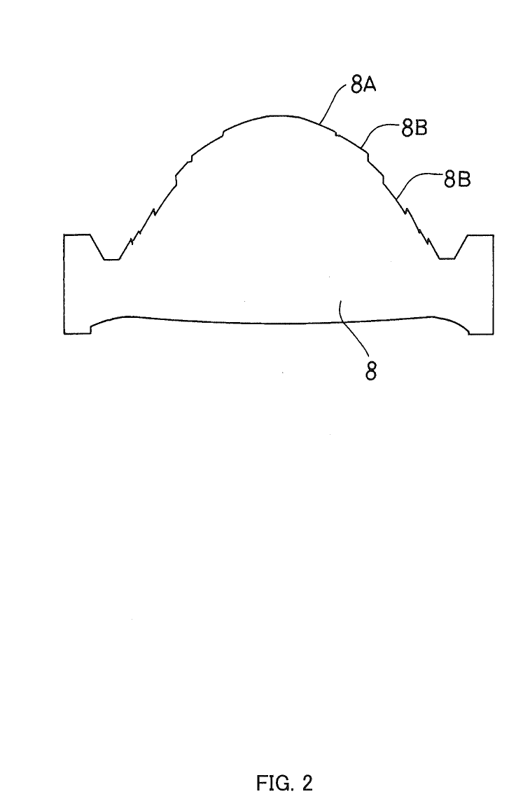

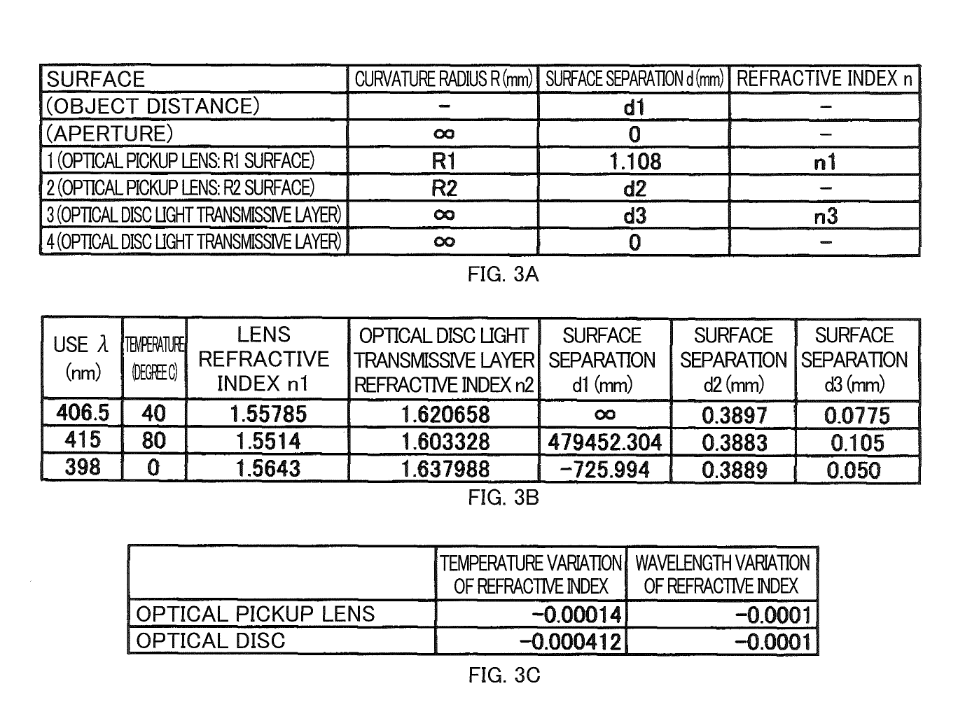

An embodiment of the present invention has been conceived in view of the above described characteristics and will be described with reference to FIGS. 1A, 1B, and 2. The objective lens according to an embodiment of the present invention is formed by forming annular zone steps 8B on an incident surface 8A of the objective lens 8 depicted in FIG. 2 and by implementing the optical design of such annular zone steps 8B under two different conditions.

In FIG. 1A, 0° C. to 80° C. are assumed as use environment, and 398 nm to 415 nm are assumed as use wavelengths. In this case, the reference temperature H1 is 40° C., i.e., a temperature intermediate between 0° C. and 80° C. of the use environment, and the wavelength of the laser beam is 406.5 nm, i.e., a wavelength intermediate between 398 nm and 415 nm and defined as the reference wavelength λ₁.

With regard to the thickness assumed as the signal recording layers, a basic optical design (first optical design) is made where an aspheric surface of the objective lens 8 is designed such that the laser beam is condensed on the position between the signal recording layer L1 and the signal recording layer L2, e.g., the intermediate position of 0.0775 mm.

In FIG. 1B, an assumed optical design (second optical design) is made where the curvature, etc., of the objective lens 8 is designed such that the laser beam is condensed on the signal recording layer L2 at the high temperature H3 such as 80° C. higher than the reference temperature H1, for example, in the state of the highest temperature ensuring the signal reading characteristics of the optical pickup apparatus. In the case of the assumed optical design, i.e., in the environment of 80° C., the wavelength of the laser beam emitted from the laser diode 1 becomes longer as the temperature rises and shorter as the temperature falls by the order of 0.05 to 0.06 nm/° C. in general. When the reference temperature H1 is 40° C., if the high temperature H3 is set at 80° C., the wavelength becomes longer by 2 nm to 2.4 nm, resulting in the laser wavelength of about 408.5 nm to 408.9 nm, which is longer than the wavelength of 406.5 nm. In a first embodiment of the present invention, the wavelength is assumed to be 415 nm in consideration of variation in laser.

Based on such a change in wavelength of the laser beam and a change in refractive index of the objective lens 8, the optical design is made for the objective lens 8 so as to condense the laser beam on the signal recording layer L2. Such an optical design is made by forming a plurality of the annular zone steps 8B on the incident surface 8A of the objective lens 8, as depicted in FIG. 2. That is to say, the optical design is made for the annular zone steps 8B so as to form steps designed in accordance with the above described basic optical design and steps designed in accordance with the assumed optical design.

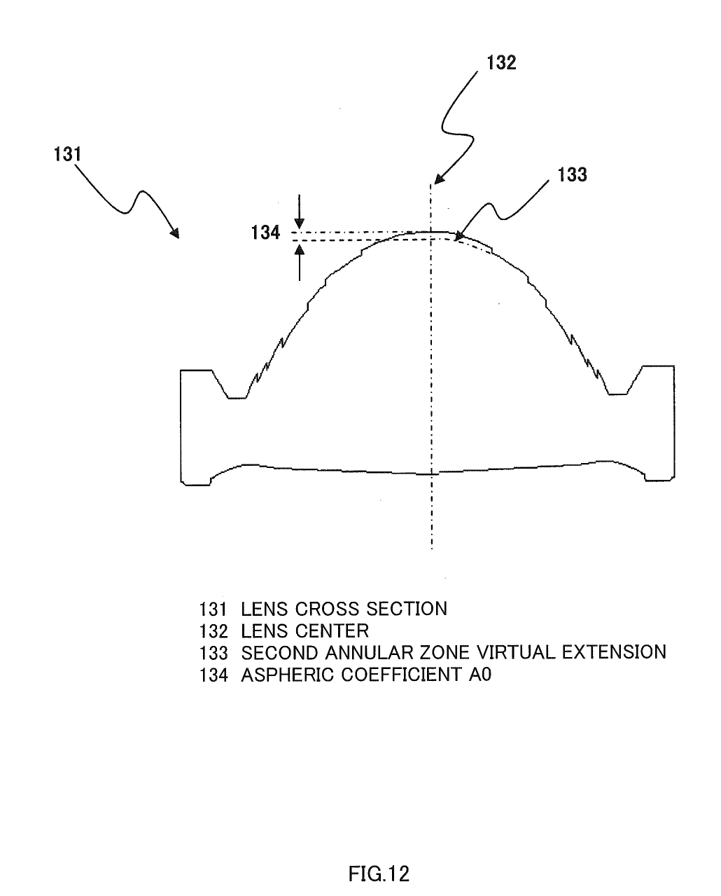

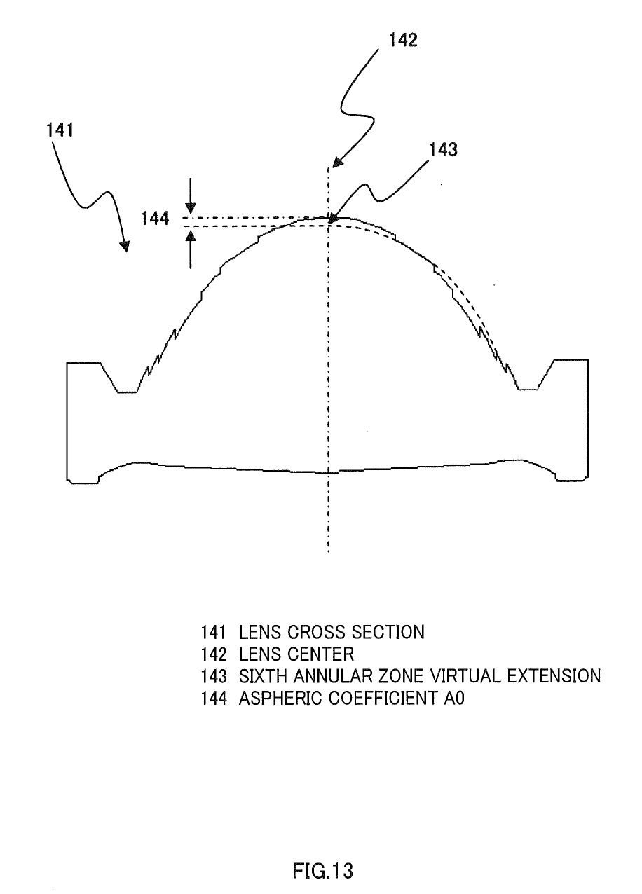

Therefore, when designing the annular zone steps 8B formed on the incident surface 8A of the objective lens 8, the aspheric coefficients with respect to the steps are set such that spherical aberration is reduced. The design is made satisfying a relational expression of (n−1)×A0=M═1 (where M is a constant) as the condition for forming the annular zone steps having such a function on the incident surface 8A of the objective lens 8, where n is a refractive index of the lens when using the laser beam having the reference wavelength λ1 at the reference temperature H1, and A0 is a distance between a surface acquired by virtually extending an annular zone surface having an annular zone step formed therein to the center of the lens and the center of the lens surface on the laser incident surface side, and a relational expression of |(n−1)×((AX+1)−AX)|=m═1 is satisfied where AX and AX+1 are A0s of the Xth annular zone and the (X+1)th annular zone, respectively, that are annular zones adjacent toward the outer circumference in the annular zones on the laser incident surface side. In this expression, m is a constant. In the case of a six-annular zone lens, A0 described above is a distance indicated by 134 in FIGS. 12 and 144 in FIG. 13.

The wavelength λ1 is preferably set so as to be an intermediate wavelength in the wavelengths assumed to be used, and for example, if it is assumed to use 398 to 415 nm in the use environment, the wavelength λ1 is preferably set at the intermediate wavelength of 406.5 nm. For the refractive index n, if it is assumed to use 0 to 80° C. in the use environment, the refractive index n in the case of the intermediate temperature of 40° C. is preferably used in addition to the above described 406.5 nm. Further, when it is desired to give higher priority to the characteristics at a higher temperature in the assumed use environment, the refractive index n at a temperature higher than the intermediate temperature may be assumed, and when it is desired to give higher priority to the characteristics at a longer wavelength in the assumed use environment, the refractive index at a wavelength longer than the intermediate wavelength may be assumed. By adjusting the temperature and the wavelength at the same time, the respective characteristics can be shifted.

As described above, in the objective lens according to an embodiment of the present invention, the optical design of the objective lens 8 at the reference temperature H1 is made such that the laser beam is condensed between the signal recording layer L1 and the signal recording layer L2, and the optical design of the objective lens 8 at the high temperature H3 is made such that the laser beam is condensed on the signal recording layer L2 disposed at the position farthest from the incident surface of the optical disc D, thereby being able to retain the aberration correction sensitivity of correcting the third-order coma aberration, and providing favorable signal reading characteristics for all the signal recording layers even at high temperature.

A description will be given of a design example of the objective lens according to an embodiment of the present invention.

The aspheric equation of the R1 surface is expressed by using h and x as follows:

$$2 \\ {Z}_{x} = \frac{h {1}^{2}}{R 1 ( 1 + \sqrt{1 - \frac{( 1 + K 1 ) h {1}^{2}}{R {1}^{2}}} )} + {A}_{1} 0 h {1}^{0} + {A}_{1} 4 h {1}^{4} + {A}_{1} 6 h {1}^{6} + {A}_{1} 8 h {1}^{8} + {A}_{1} 10 h {1}^{10} + {A}_{1} 12 h {1}^{12} + {A}_{1} 14 h {1}^{14} + {A}_{1} 16 h {1}^{16} … \qquad < Eq . 1 >$$

and the aspheric equation of the R2 surface is expressed as follows:

$$\\ Z = \frac{h {2}^{2}}{R 2 ( 1 + \sqrt{1 - \frac{( 1 + K 2 ) h {2}^{2}}{R {2}^{2}}} )} + {A}_{2} 4 h {2}^{4} + {A}_{2} 6 h {2}^{4} + {A}_{2} 8 h {2}^{8} + {A}_{2} 10 h {2}^{10} + {A}_{2} 12 h {2}^{12} + {A}_{2} 14 h {1}^{14} + {A}_{2} 16 h {2}^{16} … \qquad < Eq . 2 >$$

where an R1 surface is a surface of the objective lens on which the laser beam is incident; an R2 surface is a surface on the optical disc side; a sign in a positive direction indicates a direction from the R1 surface to the R2 surface; and a height from the light axis is h (mm).

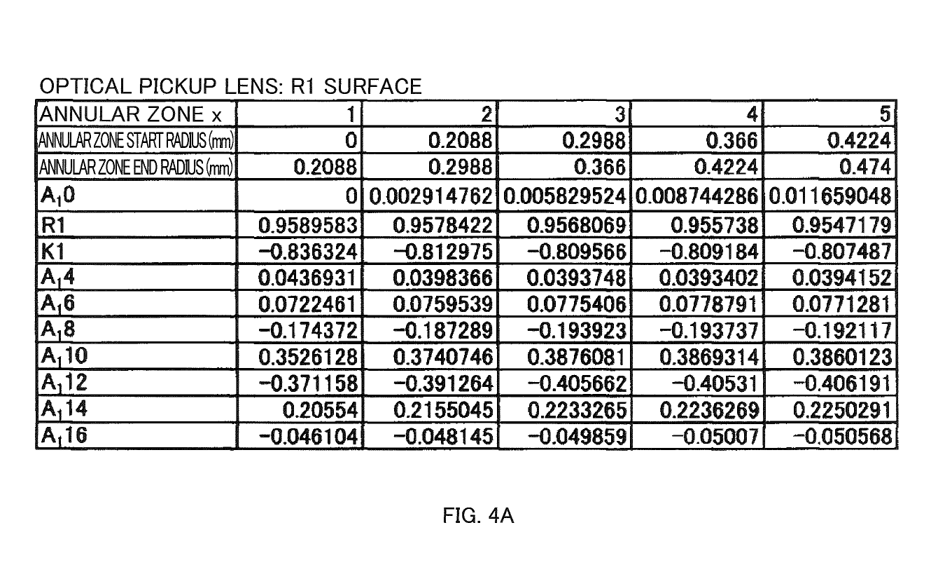

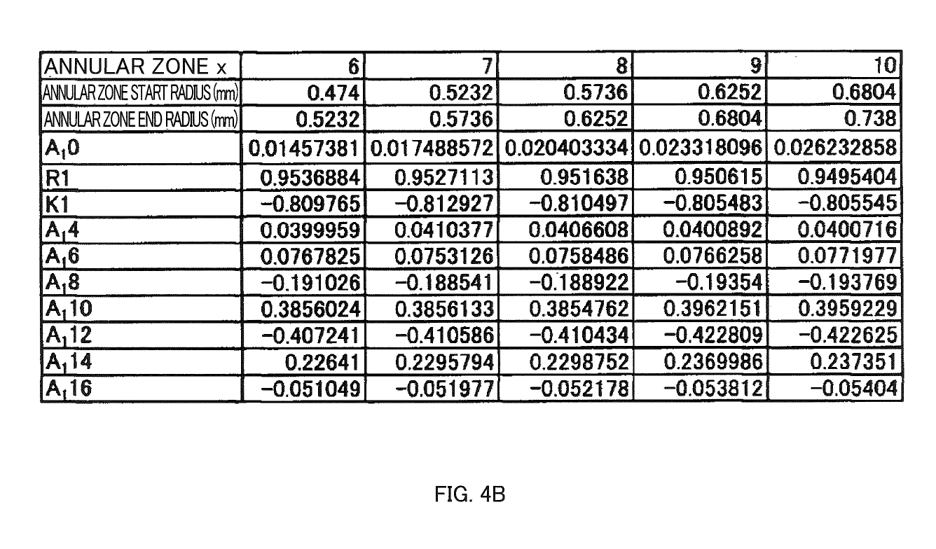

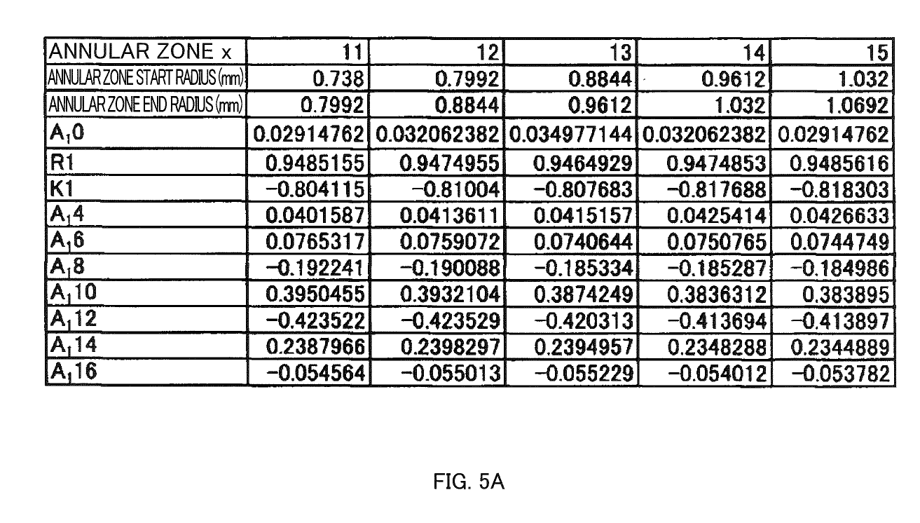

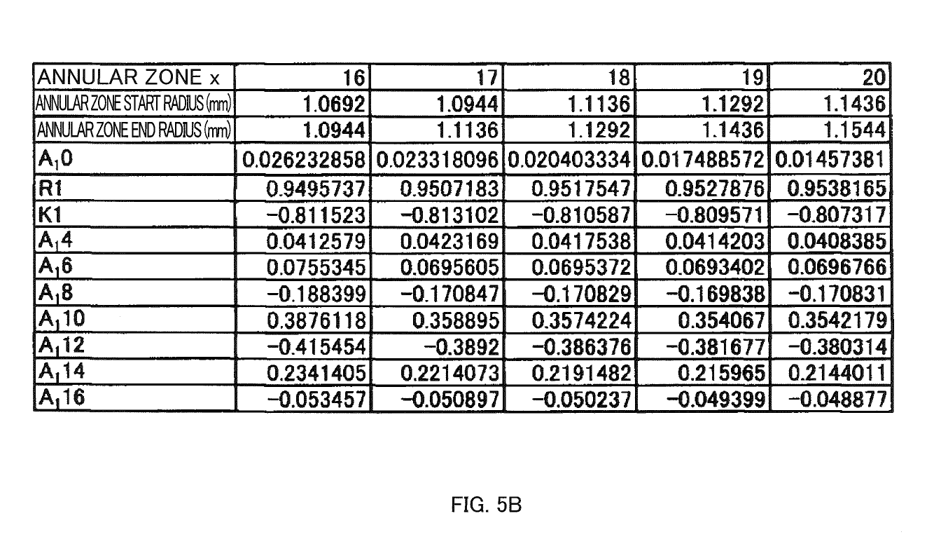

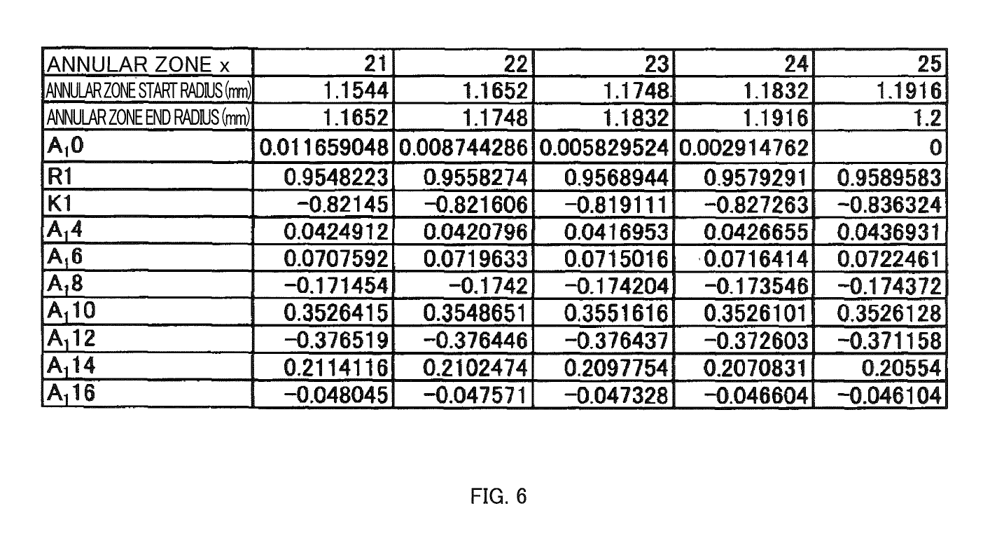

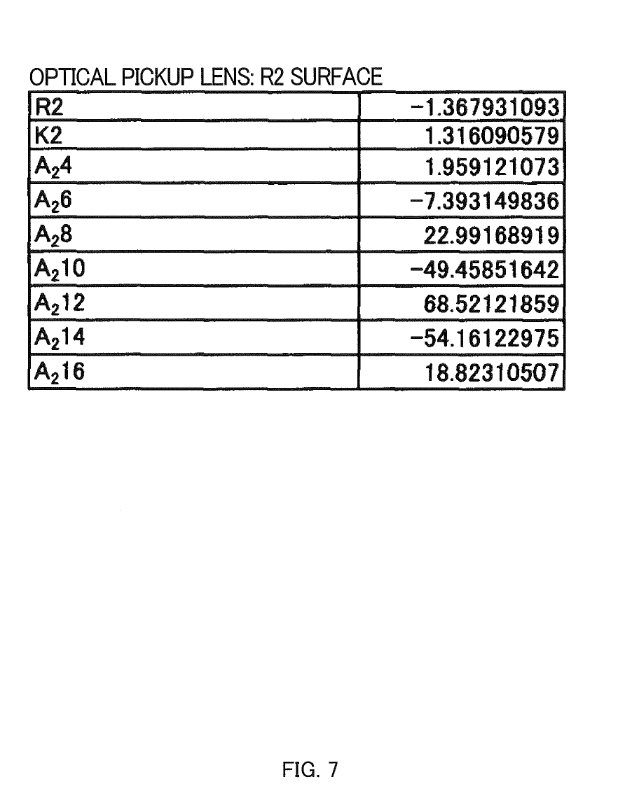

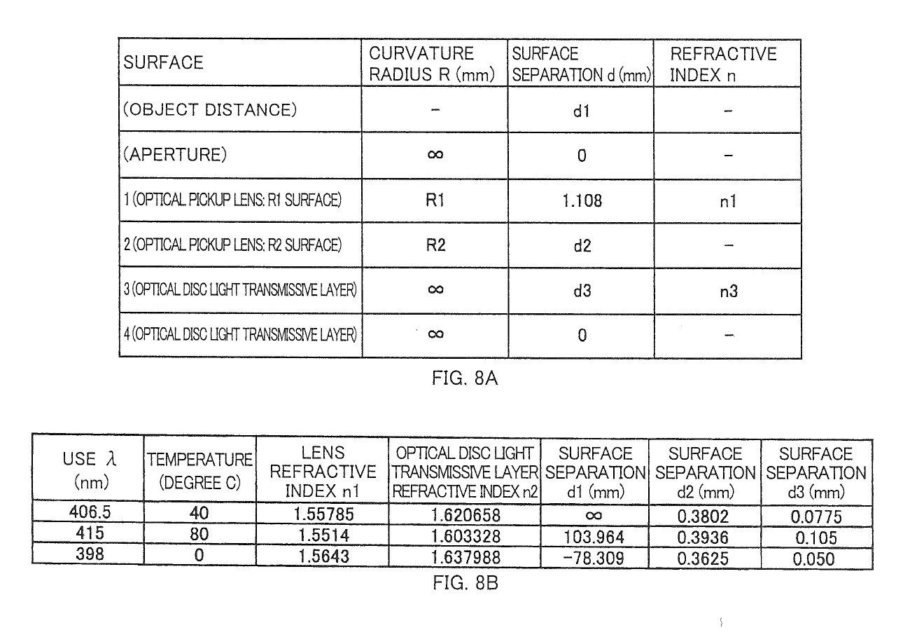

FIGS. 3A to 3C depict conditions used for optical design of an actual objective lens, and when the order m described above is 4, the number of the annular zone steps formed on R1, i.e., the surface on the incident surface side of the objective lens is 25. FIGS. 4A, 4B, 5A, 5B, and 6 depict design data on the annular zones. FIG. 7 is design data of R2 that is the surface of the objective lens on the optical disc side.

In the objective lens designed with the data depicted in FIGS. 3A to 3C, an annular zone 12 and an annular zone 14 are set equal in distance A₁0 between an annular zone surface, having the annular zone step formed therein, and the center of the lens surface on the laser incident surface side is set equal, thereby acquiring desired characteristics.

In the optical design of the objective lens 8 according to an embodiment of the present invention, it is assumed that a laser beam of infinite light or weakly finite light is incident on the objective lens 8 to be condensed on the optical disc. The objective lens 8 is designed such that the minimum aberration does not exceed the Marechal limit if the weakly finite light is incident on the objective lens 8 that is designed for the infinite light.

The infinite light is generated, within the optical pickup apparatus, by interposing the collimator lens 5 in the optical path through which the laser beam passes.

In the case of an optical disc of BD standard including four information recording layers, the outermost information recording layer is coated with a coating layer having a thickness of 0.050 mm, and the innermost information recording layer is covered with a coating layer having a thickness of 0.105 mm. In this case, the objective lens 8 is designed such that the laser beam of the infinite light is condensed on an information recording layer coated with a coating layer having a thickness of 0.0775 mm, which is a value intermediate between the both layers. When the incident laser bean turns to the weakly finite light, the objective lens 8 condenses the laser bean on the desired information recording layer.

The above described weakly finite light is created by moving the collimator lens 5 interposed in the optical path of the laser beam. That is to say, the weakly finite light indicates diverging light and converging light incident on the objective lens 8 at an angel required for displacing the focus of the objective lens 8 to each of the information recording layers of the optical disc wherein the focus of the objective lens 8 is set at a position of the thickness intermediate between the coating layers of the multilayer disc when the infinite light is incident thereon.

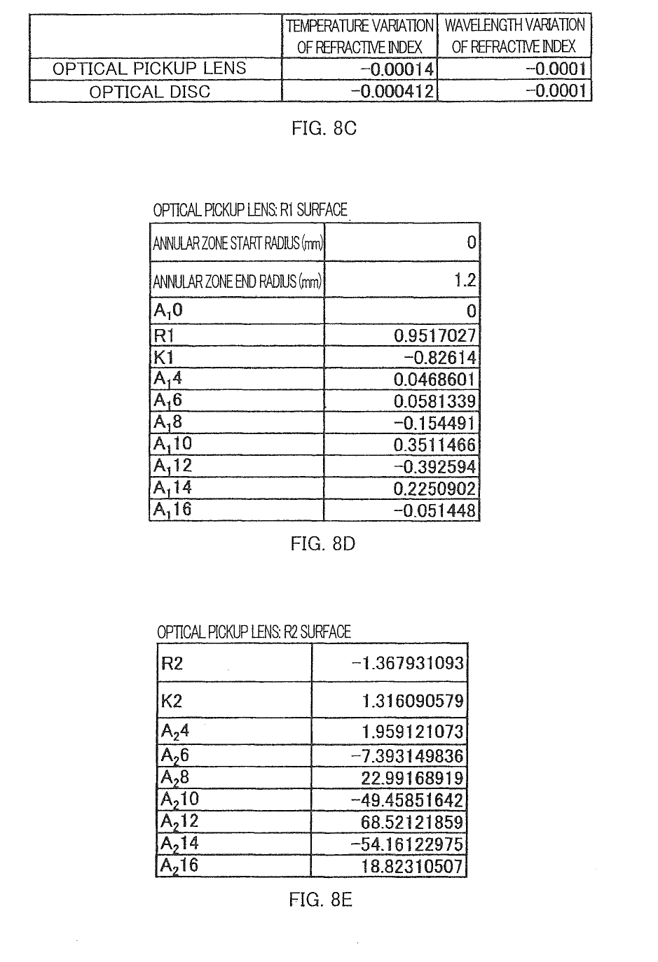

FIGS. 8A to 8E depict data for an objective lens having a single aspheric surface, i.e., an objective lens without annular zone, and depict an optical pickup lens before the annular zones, defined in an embodiment of the present invention, are formed. The design data depicted in FIGS. 3A to 3C and 4 to 7 represent the objective lens having the annular zones, defined in an embodiment of the present invention, formed, and although codes described in FIGS. 3A to 3C, 4 to 7, and 8A to 8E are generally used in optical design, these codes will hereinafter be described.

Curvature radius, surface separation, and refractive index are defined as R, d, and n, respectively, and corresponding conditions are represented by adding a number as an index to an alphabetical character such as R1 and R2. An object distance is denoted by d1, and if d1 is infinite, this means incidence of parallel light. A distance from the top of the lens surface of the objective lens on the disc side to the disc is denoted by d2, and a disc thickness is denoted by d3. The refractive index of the objective lens is denoted by n1, and the refractive index of the disc is denoted by n3. The places using R1 and R2 as curvature radiuses represent curvature radiuses of a surface (R1 surface) closer to the laser light source and a surface (R2 surface) closer to the disc, respectively.

In the aspheric equations such as those used for the above described Equation 1 and Equation 2, k denotes the conic constant; A0 to A16 denote aspheric coefficients; and h denotes a distance orthogonal to the light axis, i.e., arbitrary radius of the lens surface. The aspheric coefficient is separately represented by using an index ₁ or ₂ for each of the lens surfaces.

In the objective lens according to an embodiment of the present invention designed with the data depicted in FIGS. 3A to 3C, 4A, 4B, 5A, 5B, 6, and 7, the use environment is assumed where the wavelength is 398 to 415 nm, the temperature is 0 to 80° C., and the thickness of the signal recording layer is 0.05 to 0.105 mm (i.e., a distance from the incident surface of the optical disc to the signal recording layer). The objective lens designed with the data depicted in FIGS. 8A to 8E is designed with the design wavelength of 405.5 nm, the design temperature of 40° C., and the thickness of the signal recording layer of 0.0775 mm. In the objective lens according to an embodiment of the present invention, the design wavelength of 415 nm, the design temperature of 80° C., and the thickness of the signal recording layer of 0.105 mm are used in addition to the design condition used in FIGS. 8A to 8E, thereby setting the annular zone under both the conditions.

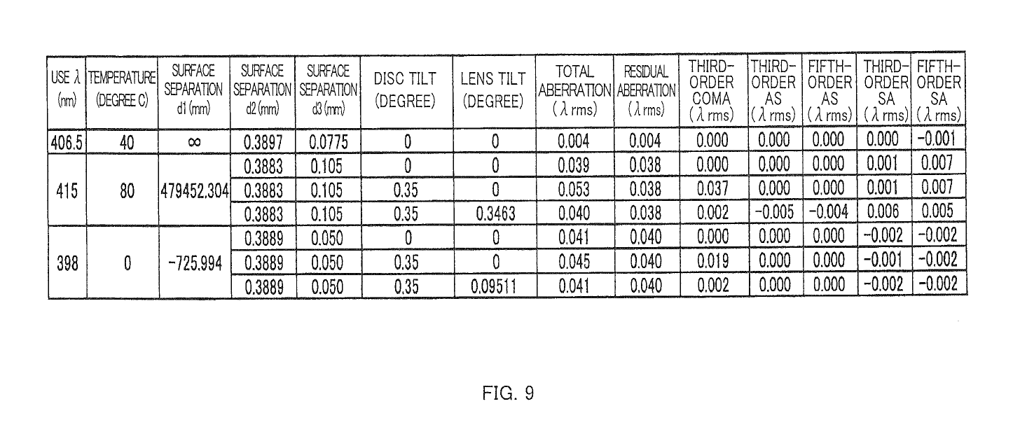

FIG. 9 is a diagram indicating an aberration amount, etc., in the objective lens designed as in the data depicted in FIGS. 3A to 3C, 4A, 4B, 5A, 5B, 6, and 7, and FIG. 10 is a diagram indicating an aberration amount, etc., in the objective lens designed as in the data depicted in FIGS. 8A to 8E.

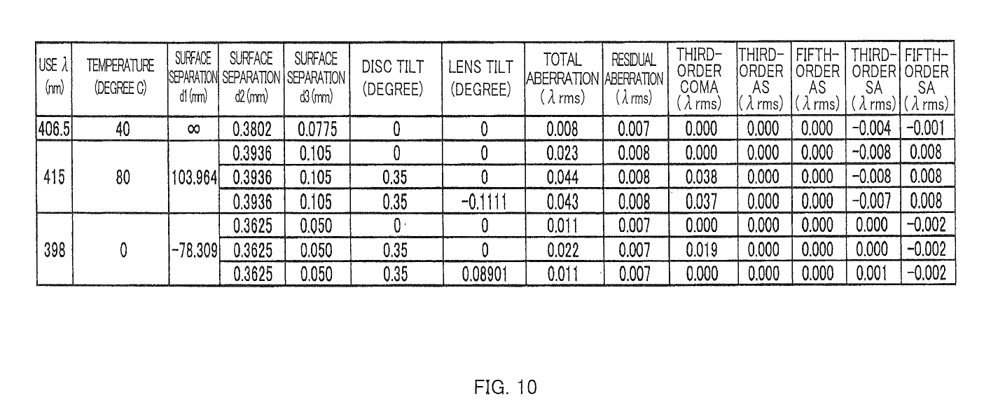

Description will then be given by comparing the characteristics of the objective lens formed by the optical design according to an embodiment of the present invention depicted in FIG. 9 with the characteristics of the objective lens formed by the typical optical design depicted in FIG. 10.

In the data depicted in FIG. 10, the temperature of 80° C., the wavelength of 415 nm, the thickness to the signal recording layer of 0.105 mm, and the disc tilt of 0.35 degrees cause a TOTAL (total) aberration of 0.044 λrms and a third-order COMA aberration of 0.038 λrms; a lens tilt operation is performed to reduce the TOTAL aberration in this case; however, the lens tilt of −0.1111 degrees can only be achieved in the case of such a high temperature; and therefore, the TOTAL aberration and the third-order COMA aberration can only slightly be improved to 0.043 λrms and 0.037 λrms, respectively.

The surface separation d1 when the aberration is minimized at the temperature of 80° C. with the wavelength of 415 nm and the thickness to the signal recording layer of 0.105 mm, is 103.964 mm, and in this case the third-order spherical aberration is −0.008 λrms, and thus, the third-order spherical aberration is corrected only by the collimator lens 5 in this design.

In contrast to such an objective lens of typical design, it can be seen that the objective lens designed according to an embodiment of the present invention is improved as in the data depicted in FIG. 9. Specifically, in an embodiment of the present invention, the temperature of 80° C., the wavelength of 415 nm, the thickness to the signal recording layer of 0.105 mm, and the disc tilt of 0.35 degrees cause a TOTAL aberration of 0.053 λrms and a third-order COMA aberration of 0.037 λrms; a lens tilt operation is performed to reduce the TOTAL aberration in such a case; the lens tilt of 0.3463 degrees can be performed in the case of such a high temperature, thereby being able to achieve the TOTAL aberration of 0.040 λrms and the third-order COMA aberration of 0.002 λrms, and reduce and improve the third-order COMA aberration.

In the objective lens designed according to an embodiment of the present invention, the surface separation d1 when the aberration is minimized at the temperature of 80° C. with the wavelength of 415 nm and the thickness to the signal recording layer of 0.105 mm, is 479452.304 mm, and since the third-order spherical aberration in this case is 0.001 λrms, the third-order spherical aberration is substantially corrected without adjustment of the collimator lens 5 in this design. In the objective lens designed according to an embodiment of the present invention, the surface separation d1 when the aberration is minimized at the temperature of 40° C. with the wavelength of 406.5 nm and the thickness to the signal recording layer of 0.0775 mm, is infinity, and in this case the third-order spherical aberration is 0.000 λrms, and thus the third-order spherical aberration is corrected without adjustment of the collimator lens 5 in this design.

Thus, the objective lens designed according to an embodiment of the present invention is designed such that the third-order spherical aberration is corrected and reduced, as compared to that in the case of an objective lens of typical design, at the highest temperature with the highest wavelength and the highest recording layer thickness, assumed to be used, i.e., at the temperature of 80° C. with the wavelength of 415 nm and the thickness to the signal recording layer of 0.105 mm as well as at the temperature of 40° C. with the wavelength of 406.5 nm, and the thickness to the signal recording layer of 0.0775 mm.

In the data depicted in FIG. 10, the TOTAL (total) aberration is 0.022 λrms and the third-order COMA aberration is 0.019 λrms when the temperature is 0° C., the wavelength is 398 nm, the thickness to the signal recording layer is 0.050 mm, and the disc tilt is 0.35 degrees; in such a case, a lens tilt operation is performed to reduce the TOTAL aberration; the TOTAL aberration and the third-order COMA aberration can be improved to 0.011 λrms and 0.000 λrms, respectively; and thus it can be understood that usage at a lower temperature with a shorter wavelength is possible. Whereas, it can be understood that the objective lens designed according to an embodiment of the present invention can be used without problem in the characteristics of a lower temperature and a shorter wavelength as in the data depicted in FIG. 9. That is to say, in an embodiment of the present invention, the TOTAL aberration is 0.037 λrms and the third-order COMA aberration is 0.019 λrms when the temperature is 0° C., the wavelength is 398 nm, the thickness to the signal recording layer is 0.050 mm, and the disc tilt is 0.35 degrees, and in such a case, a lens tilt operation is performed to reduce the TOTAL aberration, resulting in the TOTAL aberration of 0.032 λrms and the third-order COMA aberration of 0.002 λrms, thereby being able to reduce and improve the third-order COMA aberration, and thus it can be understood that the objective lens can be used at a lower temperature with a shorter wavelength.

The angle of the lens tilt described in FIGS. 9 and 10 is an angle at which the TOTAL aberration is minimized by performing the lens tilt operation relative to the disc tilt.

The number of the annular zone steps is increased as the value of the above described constant m is reduced. For example, when the constant m is three, the number of the annular zone steps is 33. The number of the annular zone steps can be reduced as the constant m is increased, however, a step amount, i.e., d is increased, resulting in an increase in residual aberration. Such residual aberration is aberration of a higher order equal to or greater than 36 ZERNIKE terms. The reason why such an aberration is generated is that spherical aberrations are generated in individual annular zones since the annular zones are provided and these spherical aberrations are generated in the limited ranges from the starts to the ends of the annular zones, resulting in the higher-order aberration.

Since such residual aberrations are higher-order aberrations, the quality of the light spot is deteriorated, however, the lower-order aberration equal or less than 36 ZERNIKE terms is not affected. That is to say, since the lower-order aberration is not affected, it can be understood that the third-order coma aberration can be corrected by the lens tilt.

As apparent from the data depicted in FIG. 9, according to an embodiment of the present invention, the objective lens can be created that is capable of correcting the third-order coma aberration by the lens tilt at a temperature of from lower temperature to higher temperature.

The above embodiments of the present invention are simply for facilitating the understanding of the present invention and are not in any way to be construed as limiting the present invention. The present invention may variously be changed or altered without departing from its spirit and encompass equivalents thereof. Although a description has been made in an embodiment of the present invention of the objective lens included in the optical pickup apparatus capable of performing the operation of reading signals recorded in the optical disc provided with four signal recording layers, it can be implemented in an objective lens included in an optical pickup apparatus provided with two layers, three layers, and more signal recording layers.

Although the high temperature H3, the low temperature H2, and the reference temperature are set at 80° C., 0° C., and 40° C., respectively, these temperatures are not limited and can variously be selected and set. Although the position set between the signal recording layers L1 and L2 in a first embodiment is set at a value in the middle between the signal recording layers L1 and L2, i.e., 0.0775 mm, this position is not limited. Further, although the reference wavelength λ1 is set at 406.5 mm just in the middle between the short wavelength λ2 and the long wavelength λ3 in a first embodiment, this position is not limited.

Still further, an objective lens may have an antireflection film formed on a lens surface in order to improve transmittance, however, the antireflection film may be formed on the lens surface since there is no dependence on transmittance in an embodiment of the present invention.

1. A method for designing an objective lens included in an optical pickup apparatus configured to read, using a laser beam, signals recorded in an optical disc having a first signal recording layer and a second signal recording layer, the second signal recording layer located at a distance from a laser beam incident surface longer than a distance from the incident surface to the first signal recording layer, comprising:
designing a first objective lens, having no annular zone formed on an incident surface on an opposite side to a side facing the optical disc, in accordance with a first optical design with which the laser beam is condensed on a layer between the first and the second signal recording layers, under conditions including a third temperature between a first temperature and a second temperature higher than the first temperature within a temperature range set as use environment of the optical pickup apparatus, and including a third wavelength between a first wavelength and a second wavelength longer than the first wavelength within a wavelength range of the laser beam set as the use environment of the optical pickup apparatus; and
designing a second objective lens in accordance with a second optical design with which the laser beam is condensed on the second signal recording layer under the conditions including the second temperature and the second wavelength, the second objective lens having an annular zone formed on the incident surface of the first objective lens, the annular zone having such an aspheric coefficient that spherical aberration becomes smaller than spherical aberration of the first objective lens.

2. The method designing an objective lens of claim 1, wherein
the laser beam to be incident on the incident surfaces of the first objective lens and the second objective lens is infinite or weakly finite, in the first optical design and the second optical design.

3. The method for designing an objective lens of claim 1, wherein
the first temperature is the minimum temperature to ensure reading characteristics of the optical pickup apparatus, and wherein
the second temperature is the maximum temperature to ensure the reading characteristics of the optical pickup apparatus.

4. The method for designing an objective lens of claim 1, wherein
the first wavelength is the shortest wavelength to ensure reading characteristics of the optical pickup apparatus, and wherein
the second wavelength is the longest wavelength to ensure the reading characteristics of the optical pickup apparatus.

5. The method for designing an objective lens of claim 1, wherein
a relational expression:
(n−1)·A0=Mλ1
(where M is a constant and λ1 and A0 are in the same unit) is satisfied
where n is a refractive index of the second objective lens when the wavelength of the laser beam is the third wavelength at the third temperature, and A0 is a distance between a surface acquired by virtually extending the annular zone having an annular zone step formed therein to the center of the second objective lens and the center of the incident surface of the second objective lens.

6. The method for designing an objective lens of claim 5, wherein
a relational expression:
(n−1)·((AX+1)−AX)=mλ1
(where m is a constant, and λ1, AX, and AX+1 are in the same unit) is satisfied
where AX and AX+1 are the A0s of the two annular zones adjacently formed from the inner circumferential side to the outer circumferential side of the incident surface of the objective lens, respectively.

7. The method for designing an objective lens of claim 6, wherein
when a direction from a laser source, configured to generate the laser beam, to the incident surface of the optical disc is of positive sign, the maximum A0 is of positive sign.

8. The method for designing an objective lens of claim 5, wherein
when a direction from a laser source, configured to generate the laser beam, to the incident surface of the optical disc is of positive sign, the maximum A0 is of positive sign, wherein
the annular zone having the A0 is defined as an Xth annular zone, and wherein
when AX−1, A0, and AX+1 are respective distances between the center of the incident surface of the objective lens and surfaces acquired by virtually extending, to the center of the second objective lens, the three annular zones having annular zone steps adjacently formed from the inner circumferential side to the outer circumferential side of the incident surface of the objective lens, the AX−1 and the AX+1 have a relationship where the AX−1 and the AX+1 are substantially equal to each other.

9. The method for designing an objective lens of claim 1, wherein
numerical aperture is equal to or greater than 0.84.

10. The method for designing an objective lens of claim 1, wherein
the first wavelength is 398 nm, and
the second wavelength is 415 nm.

11. The method for designing an objective lens of claim 1, wherein
the first temperature is 0° C., and
the second temperature is 80° C.

12. The method for designing an objective lens of claim 1, wherein
a distance from the incident surface of the optical disc to the first signal recording layer is 0.0050 mm, and
a distance from the incident surface of the optical disc to the second signal recording layer is 0.105 mm.

13. The method for designing an objective lens of claim 1, wherein
plastic is used as a material for formation.

14. The method for designing an objective lens of claim 13, wherein
an antireflection film is formed on at least one of a surface on a side facing the incident surface of the optical disc and a surface on an opposite side to the side facing the incident surface of the optical disc.

15. The method for designing an objective lens of claim 1, wherein
the third temperature is a temperature intermediate between the first temperature and the second temperature.

16. The method for designing an objective lens of claim 1, wherein
the third wavelength is a wavelength intermediate between the first wavelength and the second wavelength.

17. The method for designing an objective lens of claim 1, wherein
the layer between the first and the second signal recording layers is a layer intermediate between the first and the second signal recording layers.

18. An objective lens created by the method designing an objective lens of claim 1.

19. An objective lens included in an optical pickup apparatus configured to read, using a laser beam, signals recorded in an optical disc having a first signal recording layer and a second signal recording layer, the second signal recording layer located at a distance from a laser beam incident surface longer than a distance from the incident surface to the first signal recording layer,
the objective lens having aspheric surfaces of an incident surface and a surface on the optical disc side set in accordance with a first optical design, the first optical design with which the laser beam is condensed on a layer between the first and the second signal recording layers, under conditions including a third temperature between a first temperature and a second temperature higher than the first temperature within a temperature range set as use environment of the optical pickup apparatus, and including a third wavelength between a first wavelength and a second wavelength longer than the first wavelength within a wavelength range of the laser beam set as the use environment of the optical pickup apparatus,
the objective lens having an annular zone formed on the aspheric surface of the incident surface of the objective lens in accordance with a second optical design with which the laser beam is condensed on the second signal recording layer under the conditions including the second temperature and the second wavelength, the annular zone having such an aspheric coefficient that spherical aberration is reduced.
